(19) United States
(12) Patent Application Publication
(10) Pub. No.: US 2026/0049234 A1
(43) Pub. Date: Feb. 19, 2026

(54) Ethylene-Acrylic Acid Copolymer with Excellent Long-Lasting Adhesion and Method for Preparing the Same

(71) Applicants: SK Innovation Co., Ltd., Seoul (KR); SK Geo Centric Co., Ltd., Seoul (KR)

(72) Inventors: In Su Lee, Daejeon (KR); Doh Yeon Park, Daejeon (KR); Estopa Montserrat Garcia, Seoul (KR); Byoung Kyu Kwack, Daejeon (KR); Il Young Kwon, Daejeon (KR); Hong Chan Kim, Daejeon (KR); Sang Ha Son, Daejeon (KR); Ho Seong Lee, Daejeon (KR); Manuel Recasens, Seoul (KR)

(21) Appl. No.: 19/270,550

(22) Filed: Jul. 16, 2025

(30) Foreign Application Priority Data
Jul. 17, 2024 (KR) 10-2024-0094414

(51) Int. Cl. C09J 123/08; C08F 210/02; C08J 5/12; C09J 5/00

(52) U.S. Cl. CPC C09J 123/0869; C08F 210/02; C08J 5/128; C09J 5/00; C08F 2800/20; C08J 2323/06; C08J 2423/08; C09J 2400/166; C09J 2423/048

(57) ABSTRACT

Provided is an ethylene-acrylic acid copolymer which may maintain high initial adhesive properties for a long time by having a zero shear viscosity (η₀) and a storage modulus (G′) in specific ranges.

### CROSS-REFERENCE TO RELATED APPLICATION

This application claims priority to Korean Patent Application No. 10-2024-0094414 filed Jul. 17, 2024, the disclosure of which is hereby incorporated by reference in its entirety.

### BACKGROUND

### Technical Field

The following disclosure relates to an ethylene-acrylic acid copolymer and a method for preparing the same, and to an ethylene-acrylic acid copolymer which can maintain high initial adhesive strength over an extended period of time.

### Technical Considerations

An ethylene-acrylic acid copolymer (EAA) is being used in various fields as a high-value added chemical product, and is mainly used as, for example, an adhesive for thin packaging materials such as aluminum foil used in milk cartons and detergent packaging as a functional adhesive resin.

However, the ethylene-acrylic acid copolymer needs high pressure equipment in a manufacturing process and requires advanced technology of producing products at high acidity and the like. For example, copolymerization of an ethylene monomer and a carboxylic acid monomer uses a high pressure free radical copolymerization system and is performed by an autoclave reactor or a tube type reactor.

When the ethylene-acrylic acid copolymer is applied or thermally adhered on the surface of a polymer film, paper, a metal foil, textile, and the like, it has excellent adhesive properties initially, but has a limit to adhesive strength which deteriorates over time.

Therefore, an ethylene-acrylic acid copolymer which may stably maintain high initial adhesive properties for a long time after adhesion is needed.

### SUMMARY

In some non-limiting embodiments, the present disclosure is directed to providing an ethylene-acrylic acid copolymer which may maintain high initial adhesive properties for a long time and a method for preparing the same.

In some non-limiting aspects, an ethylene-acrylic acid copolymer which has a zero shear viscosity (η₀) at 170° C. of 3,800 Pa·s or more and a storage modulus (G′) of 90 Pa or more at a loss modulus (G″) of 500 Pa as measured at a crossover frequency of 0.01 to 20 Hz at 170° C. is provided.

In some non-limiting embodiments, in the ethylene-acrylic acid copolymer in which a log M value of maximum dw/dlog M satisfies the following Equation 1, the ethylene-acrylic acid copolymer having a cumulative concentration fraction of 0.75 or more may have a weight average molecular weight of 220,000 g/mol or more:

$$4.2 \leq log M \leq 4.8 \qquad [ Equation 1 ]$$

wherein log M is a logarithmic value of a molecular weight M as a horizontal axis of the ethylene-acrylic acid copolymer measured by gel permeation chromatography, and in the range of log M, a maximum peak value of dw/dlog M obtained by differentiating a concentration fraction w by the logarithmic value of the molecular weight, log M is included.

In some non-limiting embodiments, the ethylene-acrylic acid copolymer may have a weight average molecular weight/number average molecular weight (Mw/Mn) of 6 or more and a z average molecular weight/weight average molecular weight (Mz/Mw) of 3.9 or more.

In some non-limiting embodiments, the ethylene-acrylic acid copolymer may have a weight average molecular weight (Mw) of 90,000 g/mol or more, a number average molecular weight of 17,000 or more, and a z average molecular weight (Mz) of 400,000 g/mol or more.

In some non-limiting embodiments, in the ethylene-acrylic acid copolymer, a content of an acrylic acid structural unit may be 1 to 30 wt % of the total weight of the copolymer.

In some non-limiting embodiments, the ethylene-acrylic acid copolymer may have a melt index (190° C./2.16 kg, ASTM D 1238) of 5 to 15.

In some non-limiting embodiments, the ethylene-acrylic acid copolymer may be prepared by polymerizing monomers at a temperature of 150 to 350° C. under a pressure of 1,000 to 5,000 bar.

In some non-limiting aspects, an adhesive comprises an ethylene-acrylic acid copolymer as disclosed herein.

In some non-limiting embodiments, it may take 14 days or more for a laminated sheet obtained by co-extrusion lamination after an adhesive disclosed herein forms an adhesive layer between an aluminum metal sheet and a low-density polyethylene sheet to lose its adhesive strength in a citric acid aqueous solution (3 wt %) at 45° C.

In some non-limiting aspects, a laminated sheet wherein an adhesive comprising an ethylene-acrylic acid copolymer as disclosed herein forms an adhesive layer between a metal sheet and a polymer sheet is provided.

In some non-limiting aspects, a pack which is formed of a laminate comprising a laminated sheet as disclosed herein and a fluid housing space is provided.

Other features and aspects will be apparent from the present disclosure.

### BRIEF DESCRIPTION OF THE DRAWINGS

FIG. 1 is a graph in which changes in dw/dlog M and a cumulative concentration fraction depending on log M of the ethylene-acrylic acid copolymer of the present disclosure are measured.

### DETAILED DESCRIPTION

Hereinafter, an ethylene-acrylic acid copolymer having excellent adhesive strength and a method for preparing the same according to the present disclosure will be described in detail.

Technical terms and scientific terms used in the present specification have the general meaning understood by a person skilled in the art unless otherwise defined, and description for the known function and configuration obscuring the present disclosure will be omitted in the following description.

The singular form of the term used herein may be intended to also include a plural form, unless otherwise indicated. As used herein, the singular form of “a”, “an”, and “the” include plural referents unless the context clearly states otherwise.

For the purposes of this disclosure, unless otherwise indicated, all numbers expressing quantities of ingredients, reaction conditions, dimensions, physical characteristics, and so forth used in the disclosure are to be understood as being modified in all instances by the term “about.” Unless indicated to the contrary, the numerical parameters set forth in the present disclosure are approximations that can vary depending upon the desired properties sought to be obtained by the present disclosure.

The numerical ranges used in the present specification includes all values within the ranges including the lower limit and the upper limit, increments logically derived from the form and spanning of a defined range, all double limited values, and all possible combinations of the upper limit and the lower limit of the numerical range defined in different forms. Unless otherwise defined in the present disclosure, values which may be outside of a numerical range due to experimental error or rounding off of a value are also included in the defined numerical range.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

Also, it should be understood that any numerical range recited herein is intended to include all sub-ranges subsumed therein. For example, a range of “1 to 10” is intended to include any and all sub-ranges between and including the recited minimum value of 1 and the recited maximum value of 10, that is, all subranges beginning with a minimum value equal to or greater than 1 and ending with a maximum value equal to or less than 10, and all subranges in between, e.g., 1 to 6.3, or 5.5 to 10, or 2.7 to 6.1.

The term “comprise” mentioned in the present disclosure is an open-ended description having a meaning equivalent to the term such as “include”, “is/are provided”, “contain”, or “have”, and does not exclude elements, materials, or processes which are not further listed.

The unit of % used in the present specification without particular mention refers to & by weight, unless otherwise defined.

The term “layer” or “film” mentioned in the present disclosure means that each material forms a continuum and has a dimension having a relatively small thickness to a width and a length. Accordingly, the term “layer” or “film” in the present disclosure should not be interpreted as a two-dimensional flat plane.

An ethylene-acrylic acid copolymer (EAA) is a high value-added chemical product and is used for general purposes in various fields. For example, when the ethylene-acrylic acid copolymer is applied and adhered on a surface of an adherend having various surface materials such as polymer films, paper, metal foil, and fabric, it has excellent initial adhesive strength and is mainly used as an adhesive. However, the conventional ethylene-acrylic acid copolymer has a limitation in losing initial adhesive strength over time, after it is adhered to an adherend. Therefore, management is required for storage, transportation, and the like of products with completed adhesion, quality of the products is greatly affected over time, and the resulting costs are significant.

The conventional ethylene-acrylic acid copolymer has significantly low long-term adhesive strength, as described above.

Accordingly, in some non-limiting embodiments, the present disclosure provides an ethylene-acrylic acid copolymer having extremely excellent long-term adhesive strength as compared with the conventional copolymer, by newly specifying elements affecting the long-term adhesive strength of the ethylene-acrylic acid copolymer and defining a numerical range which may maximize long-term adhesive strength for zero shear viscosity and storage modulus as specified elements.

As a means for improving long-term adhesive properties of the ethylene-acrylic acid copolymer, in some non-limiting embodiments the ethylene-acrylic acid copolymer according to the present disclosure may have a zero shear viscosity (η₀) at 170° C. of 3,800 Pa·s or more and a storage modulus (G′) of 90 Pa or more at a loss modulus (G″) of 500 Pa as measured at a crossover frequency of 0.01 to 20 Hz at 170° C.

In some non-limiting embodiments, the ethylene-acrylic acid copolymer according to the present disclosure may have a zero shear viscosity (no) at 170° C. of 3,800 Pa·s or more, 3, 900 Pa·s or more, 4,000 Pa·s or more, 4,100 Pa·s or more, 4,200 Pa·s or more, 4,300 Pa·s or more, 4,500 Pa·s or more, 4,600 Pas or more, 4,700 Pa·s or more, 4,800 Pa·s or more, 4, 900 Pa·s or more, or 5,000 Pa·s or more, as the lower limit and 6,000 Pa·s or less, 5,500 Pa·s or less, or 5,200 Pa·s or less, as the upper limit, but is not limited thereto.

In some non-limiting embodiments, the storage modulus (G′) according to the present disclosure may be 90 Pa or more, 91 Pa or more, 92 Pa or more, 93 Pa or more, 94 Pa or more, 95 Pa or more, or 96 Pa or more, as the lower limit and 100 Pa or less or 99 Pa or less, as the upper limit, but is not limited thereto.

Thus, initial excellent adhesive properties on an adherend having various surface materials may be maintained for a long time, and, for example, long-term adhesive properties between an aluminum metal surface and a polyethylene film surface are further improved.

The zero shear viscosity is denoted as no and is a viscosity when flow of a material substantially stops. The zero shear viscosity may refer to a representative value calculated by extrapolation from a melt viscosity measured according to a change in a shear rate at a specific temperature using a rheometer. The zero shear viscosity in the present disclosure may refer to a viscosity value when a shear velocity converges to zero, calculated from melt viscosity data measured at a temperature of 170° C., in a crossover frequency range of 0.01 to 20 Hz.

The storage modulus is denoted as G′ and is a measure of stored energy, that is, a measured value for elastic components of a material. The loss modulus is denoted as G″ and is a measured value for viscosity components of a material as a measure of lost energy as heat. The storage modulus in the present disclosure may refer to an elastic modulus at a loss modulus (G″) of 500 Pa measured at 170° C., in a crossover frequency range of 0.01 to 20 Hz. The zero shear viscosity and the storage modulus are properties of a previously defined polymer, and for a more specific measurement means, the examples described herein or known documents may be referred.

In some non-limiting embodiments, in the ethylene-acrylic acid copolymer in which a log M value of maximum dw/dlog M satisfies the following Equation 1, the ethylene-acrylic acid copolymer having a cumulative concentration fraction is 0.75 or more may have a weight average molecular weight of 220,000 g/mol or more:

$$4.2 \leq log M \leq 4.8 \qquad [ Equation 1 ]$$

wherein log M is a logarithmic value of a molecular weight M as a horizontal axis of the ethylene-acrylic acid copolymer measured by gel permeation chromatography, and in the range of log M, a maximum peak value of dw/dlog M obtained by differentiating a concentration fraction w by the logarithmic value of the molecular weight, log M is included.

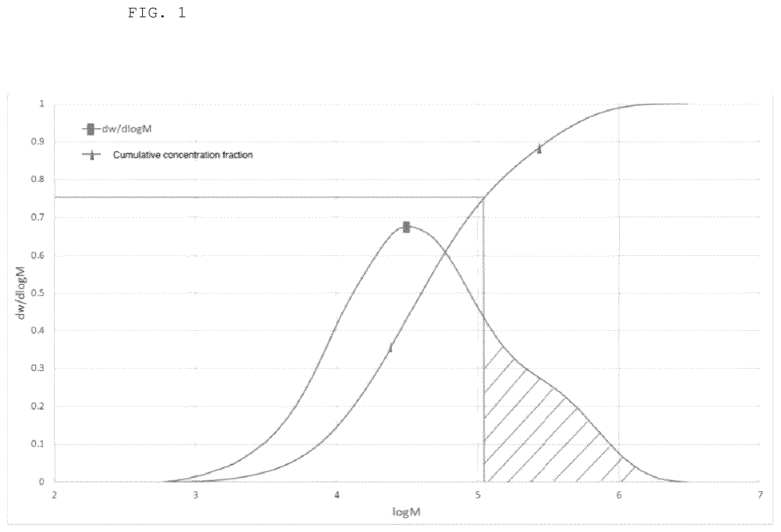

Referring to FIG. 1, in some non-limiting embodiments, the ethylene-acrylic acid copolymer of the present disclosure is based on the data measured by gel permeation chromatography in terms of polystyrene.

The ethylene-acrylic acid copolymer of the present disclosure is a copolymer having a high ratio of a high molecular weight in a differential molecular weight distribution curve in which a horizontal axis is log M which is a logarithmic value of a molecular weight M and a vertical axis is dw/dlog M obtained by differentiating a concentration fraction w by the logarithmic value of the molecular weight, log M, and this includes chromatography in a shoulder form in a polymer range. In some non-limiting embodiments, the ethylene-acrylic acid copolymer is a copolymer in which (1) the dw/dlog M value is the maximum in a range of 4.2≤log M≤4.8 and (2) the weight average molecular weight of a polymer having the cumulative concentration fraction of 0.75 or more is 220,000 g/mol or more.

In some non-limiting embodiments, the weight average molecular weight of the polymer having the cumulative concentration fraction of 0.75 or more may be 220,000 g/mol or more, 230,000 g/mol or more, 240,000 g/mol or more, or 260,000 g/mol or more, as the lower limit and 400, 000 g/mol or less, 380,000 g/mol or less, 350,000 g/mol or less, 300,000 g/mol or less, or 280,000 g/mol or less, as the upper limit, but is not limited thereto.

In some non-limiting embodiments, the weight average molecular weight/number average molecular weight (Mw/Mn) of the ethylene-acrylic acid copolymer may be 6 or more, 6.1 or more, 6.2 or more, 6.3 or more, 6.4 or more, or 6.5 or more, as the lower limit and 8 or less or 7 or less, as the upper limit, but is not limited thereto.

In some non-limiting embodiments, the z average molecular weight/weight average molecular weight (Mz/Mw) of the ethylene-acrylic acid copolymer may be 3.9 or more, 4.0 or more, or 4.1 or more, as the lower limit and 6 or less or 5 or less, as the upper limit, but is not limited thereto.

In some non-limiting embodiments, the weight average molecular weight (Mw) of the ethylene-acrylic acid copolymer may be 90,000 g/mol or more, 100,000 g/mol or more, or 110,000 g/mol or more, as the lower limit and 200, 000 g/mol or less or 150,000 g/mol or less, as the upper limit, but is not limited thereto.

In some non-limiting embodiments, the number average molecular weight of the ethylene-acrylic acid copolymer may be 17,000 g/mol or more, 17,100 g/mol or more, or 17,200 g/mol or more, as the lower limit and 20, 000 g/mol or less or 19,000 g/mol or less, as the upper limit, but is not limited thereto.

In some non-limiting embodiments, the z average molecular weight of the ethylene-acrylic acid copolymer may be 400, 000 g/mol or more, 410,000 g/mol or more, 420,000 g/mol or more, 440,000g/mol or more, 450,000 g/mol or more, 460,000 g/mol or more, or 470,000 g/mol or more, as the lower limit and 600,000 g/mol or less, 500, 000 g/mol or less, or 490, 000 g/mol or less, as the upper limit, but is not limited thereto.

In some non-limiting embodiments, the ethylene-acrylic acid copolymer according to the present disclosure may have long chain branching and may have a high ratio of a high molecular weight in the molecular weight distribution and many entanglements between polymer chains. As an example, the copolymer having the structural properties as such satisfies both the average molecular weight and the molecular weight distribution in the range described herein, thereby significantly delaying a decrease in adhesive strength over time and further improving the long-term adhesive strength described above.

The zero shear viscosity and the storage modulus may be controlled by adjusting various preparation conditions in the method for preparing the ethylene-acrylic acid copolymer. As an example, by adjusting the conditions such as polymerization pressure, polymerization temperature, the use content of an initiator, and the like, the ethylene-acrylic acid copolymer with the zero shear viscosity and the storage modulus being controlled may be provided.

The ethylene-acrylic acid copolymer to the present disclosure may be prepared by a preparation method comprising copolymerizing monomers comprising an ethylene monomer and an acrylic acid monomer to prepare an ethylene-acrylic acid copolymer, wherein the polymerization is performed under the conditions of high temperature and high pressure.

In some non-limiting embodiments, the preparation may be performed by polymerizing the monomers at a temperature of 150 to 350° C. or 180 to 300° C. In some non-limiting embodiments, the ethylene-acrylic acid copolymer may be prepared by polymerizing monomers under a pressure of 1,000 to 5,000 bar or 1,500 to 4,000 bar.

In some non-limiting embodiments, the ethylene-acrylic acid copolymer according to the present disclosure comprises an acrylic acid structural unit and an ethylene structural unit, and a content of the acrylic acid structural unit may be 1 to 30 wt %, 3 to 25 wt %, or 7 to 15 wt % of the total weight of the copolymer. When this is satisfied, high initial adhesive properties may be implemented, and the high initial adhesive properties may be maintained for a long time by satisfying the zero shear viscosity and the storage modulus in the range described above.

In some non-limiting embodiments, though the melt index (190° C./2.16 kg, ASTM D 1238) of the ethylene-acrylic acid copolymer according to the present disclosure is not limited, it may be, for example, 5 to 15, 5 to 10, or 5 to 9, but is not limited thereto.

Hereinafter, the polymerization method will be described as a non-limiting example.

In some non-limiting embodiments, the polymerization step of the present disclosure may comprise a supply step of supplying a compressed material to a reactor, the compressed material being formed by secondarily compressing a mixture comprising monomers comprising an ethylene monomer and/or an acrylic acid comonomer which have been first compressed with a first compressor, and with a second compressor which is a high pressure compressor.

In some non-limiting embodiments, in the first compressor, the ethylene monomer, and/or the acrylic acid monomer, and any other monomer(s) if present, can be compressed at a first pressure ranging from 5 to 20 barr and at a first temperature ranging from 10 to 40° C., for example, to form a first compressed material. In some non-limiting embodiments, the ethylene monomer is compressed in the first compressor to form the first compressed material.

The first compressed material can be supplied to the second compressor, along with any of the other monomer(s), and compressed at a second pressure ranging from 150 to 220 barr and at a second temperature ranging from 10 to 30° C., for example, to form a second compressed material.

For example, the first compressed material can be compressed ethylene monomer, and supplied to the second compressor along with a separate supply of acrylic acid monomer. Other monomer(s), if present for example, can be supplied with the acrylic acid monomer or separately supplied to the second compressor, but the present disclosure is not limited to these examples.

The compressed material from the second compressed material from the second compressor is supplied to the reactor and copolymerized in the reactor to synthesize the ethylene-acrylic acid copolymer. The polymerization reaction can be conducted at pressure ranging from 1,000 to 5,000 barr and at a temperature ranging from 150 to 350° C., for example. The reaction can be conducted in the presence of an initiator(s), solvent(s), chain transfer agent(s) and/or additive(s) as disclosed herein, to form the ethylene-acrylic acid copolymer.

As an exemplary embodiment, the reaction temperature in the upper portion of the reactor may be adjusted to a temperature that is at least 10° C. lower than the reaction temperature in the lower portion of the reactor, preferably a temperature difference of 12 to 15° C.

In some non-limiting embodiments, the polymerization step may further comprise a circulation step of separating an unreacted residue separated from a discharge from the reactor and resupplying the discharge to a front end of the first compressor or the second compressor. Herein, “discharge” is discharged after an ethylene-acrylic acid polymerization reaction is performed inside a reactor, in an ethylene-acrylic acid copolymer preparation process, and may comprise an ethylene copolymer and an unreacted residue. The “unreacted residue” is a material other than the ethylene-acrylic acid copolymer, in the ethylene-acrylic acid copolymer preparation process, and may comprise, for example, an unreacted ethylene monomer, an unreacted acrylic acid comonomer, a solvent, an initiator, other additive(s), and the like.

In some non-limiting embodiments, the supplying step may comprise a first supply step and a second supply step, and the ethylene monomer may be supplied in the first supply step and the acrylic acid comonomer may be supplied in the second supply step. Regarding the supply process of a reactant, the ethylene monomer supplied in the first supply step is compressed with the first compressor to produce a first material. Thereafter, the acrylic acid monomer supplied in the second supply step and the mixture comprising the first compressed material are secondarily compressed with a high pressure compressor which is the second compressor to produce a second compressed material. The produced second compressed material is supplied to the reactor, and the ethylene monomer and the acrylic acid comonomer in the second compressed material are copolymerized in the reactor to synthesize the ethylene-acrylic acid copolymer.

In some non-limiting embodiments, the reactor has a stirrer installed inside for mixing a reactant and a product, and a stirrer shaft has a baffle to divide the inside of the reactor into an upper portion and a lower portion of the reactor. The ethylene monomer and the acrylic acid comonomer are supplied separately into the upper portion and the lower portion of the reactor. However, the method for polymerizing an ethylene-acrylic acid copolymer is not defined by the presence and the number of baffles for dividing the inside of the reactor.

In some non-limiting embodiments, the circulation step may comprise a first circulation step of separating the discharge from the reactor by a high pressure separator and supplying an unreacted residue to the front end of the secondary compressor. In some non-limiting embodiments, it may comprise a second circulation step of secondarily separating the separated material from the high pressure separator by a low pressure separator and supplying an unreacted residue to the front end of the first compressor.

In some non-limiting embodiments, in the first circulation step, impurities may be discharged to the outside through a filter capable of separating the unreacted residue by filtration and removed, and impurities other than the unreacted residue may also be filtered and separated. In the second circulation step, the discharge remaining after separating the first filtered unreacted residue may be secondarily filtered to separate the remaining unreacted residue, which may be supplied to the first compressor.

In some non-limiting embodiments, in the polymerization step, the polymerization may be polymerization by an initiator, for example, may be free radical polymerization. Accordingly, the compressed material supplied to the reactor may further comprise an initiator, such as a radical initiator, and the polymerization may be performed by a reaction between each monomer under the radical initiator. As an example, the polymerization may be performed by an initiator mixed solution comprising a radical initiator and a diluting solvent. Any content of the initiator may be used as long as a radical polymerization reaction is initiated, and for example, the initiator may be used at 0.001 to 1 part by weight based on 100 parts by weight of a total monomer. In some non-limiting embodiments, a content of the diluting solvent used may be properly adjusted, and for example, 5 to 1, 000 parts by weight of the diluting solvent may be diluted and used with respect to 1 part by weight of the initiator. The initiator mixed solution may be supplied to the upper and lower portions of the reactor, respectively. However, it is only described as a specific example, and the present disclosure is not interpreted as being limited thereto.

As an example, any type of radical initiator may be used as long as radical polymerization between an ethylene monomer and an acrylic acid comonomer is performed, and, for example, a peroxy-based organic peroxide comprising any one or two or more selected from peroxycarbonate, peroxydicarbonate, peroxyester, and peroxyketal may be used. However, it is only described as a specific example, and the present disclosure is not interpreted as being limited thereto.

In some non-limiting embodiments, the diluting solvent may be a known initiator diluting solvent, and for example, the zero shear viscosity and the storage modulus may be controlled more precisely with the effect described above by using a paraffin-based solvent, for example Isopar-H of the paraffin-based solvents as the diluting solvent.

In some non-limiting embodiments, the compressed material supplied to the reactor may further comprise a chain transfer agent. As a non-limiting example, the chain transfer agent may be selected from aliphatic and olefin-based hydrocarbons, for example, compounds such as isobutane, propylene, butylene, hexane, cyclohexane, and octane; ketone-based compounds such as acetone, methyl ethyl ketone, diethyl ketone, and diamylketone; aldehyde-based compounds as such formaldehyde, acetaldehyde, and propionaldehyde; and alcohol-based compounds such as methanol, ethanol, propanol, and butanol; and the like. When the chain transfer agent is used, a content of the chain transfer agent used is not largely limited, and for example, may be used at 0.1 to 20 parts by weight with respect to 100 parts by weight of the total monomer. However, it is only described as an example, and the present disclosure is not interpreted as being limited thereto.

As described above, the ethylene-acrylic acid copolymer according to the present disclosure is used as an adhesive, and the present disclosure may provide an adhesive comprising the ethylene-acrylic acid copolymer.

In some non-limiting embodiments, the adhesive according to an exemplary embodiment of the present disclosure may further comprise an additive, and when the additive is further comprised, 0.01 to 10 parts by weight or 0.05 to 5 parts by weight of the additive may be comprised with respect to 100 parts by weight of the ethylene-acrylic acid copolymer. As a non-limiting example, the additive may comprise any one or two or more selected from pigments, dyes, defoamers, preservatives, thickeners, modifiers, humectants, nucleating agents, anti-blocking agents, processing aids, UV stabilizers, neutralizers, lubricants, surfactants, tackifiers, plasticizers, antioxidants, toning agents, reinforcement, foaming agents, and/or flame retardants, and the like, or combinations thereof. However, it is only described as a specific example, and the present disclosure is not interpreted as being limited thereto.

The adhesive according to the present disclosure, that is, the ethylene-acrylic acid copolymer may be used as an adhesive for use with various objects such as sterilization packs such as milk cartons and aluminum foil laminates, and for example, shows high adhesive properties in adherends having various surface materials such as polymer films, paper, metal foils, and fabric. In some non-limiting embodiments, the present disclosure may implement higher initial adhesive properties and higher long-term adhesive properties in adhesion between metal surfaces, adhesion between polymer films, or adhesion between a metal surface and a polymer film. As an example, adhesive properties between an aluminum metal sheet surface and a polyethylene sheet surface may be better. It may take 14 days or more or 15 days or more for a laminated sheet obtained by co-extrusion lamination after the adhesive according to an exemplary embodiment forms an adhesive layer between an aluminum metal sheet and a low-density polyethylene sheet to lose its adhesive strength under harsh conditions of adding the laminated sheet to a citric acid aqueous solution (3 wt %) at 45° C. In comparison, when the zero shear viscosity and the storage modulus in the ranges described above are not satisfied, it may take 12 days or less, which is significantly decreased by about 25% or more.

In some non-limiting embodiments, the present disclosure may provide a laminated sheet in which the adhesive, that is, the ethylene-acrylic acid copolymer forms an adhesive layer between a metal sheet and a polymer sheet. In some non-limiting embodiments, the present disclosure may provide a pack which is formed of a laminate comprising the laminated sheet and has a fluid housing space.

Hereinafter, the present disclosure will be described in detail by the examples, but the examples are for describing the present disclosure in more detail, and the scope of rights of the present disclosure is not limited to the following examples.

### Example 1

### Preparation of Ethylene-Acrylic Acid Copolymer

An ethylene monomer was supplied to the front end of a first compressor at an average flow rate of 900 kg/h, compressed in the first compressor at a temperature of 25° C. and pressure of 12 barr, and supplied to a second compressor at a pressure of 200 bar, while an acrylic acid comonomer was supplied to the second compressor at an average flow rate of 500 kg/hr, and supplied to a second compressor at a pressure of 205 bar and a temperature of 20° C., while an acrylic acid comonomer was supplied to the second compressor at an average flow rate of 500 kg/hr. An initiator mixed solution was supplied to the inside of a reactor at an average flow rate of 53 L/hr, and the upper inside of the reactor was adjusted to a temperature of 234° C. and the lower inside of the reactor was adjusted to a temperature of 248° C. and a pressure of 2,175 bar, thereby inducing a polymerization reaction. At this time, an initiator (tert-butyl peroxyacetate) diluted to 10 wt % with a diluting solvent (Isopar-H, ExxonMobil) was used as the initiator mixed solution. Further, a discharge from the reactor was supplied to a high pressure separator, and the discharge from which an unreacted residue was first separated by the high pressure separator was supplied to a low pressure separator to secondarily separate the unreacted residue. An ethylene-acrylic acid copolymer from which the unreacted residue was secondarily separated was obtained in the low pressure separator, and the acrylic acid content of the ethylene-acrylic acid copolymer at this time was 8.2 wt %.

### Measurement of Physical Properties of Ethylene-Acrylic Acid Copolymer

The zero shear viscosity (η₀), the elasticity, the average molecular weight, the polydispersity index, and the molecular weight distribution of the prepared ethylene-acrylic acid copolymer were measured, the long-term adhesive strength of the ethylene-acrylic acid copolymer was also measured, and the results therefor are shown in the following Table 1.

### 1. Measurement of Zero Shear Viscosity and Elasticity

The ethylene-acrylic acid copolymer was allowed to stand under the constant temperature and humidity conditions (temperature: 25° C., relative humidity: 45%) for 3 weeks or more after preparation so that it was aged. Further, the aged ethylene-acrylic acid copolymer was physically pressed for 10 seconds with a hot press at 160° C. to prepare a sample having a diameter of 2.5 cm and a thickness of 2 mm. Thereafter, the rheological viscosity data for elasticity of the sample was obtained using ARES G2 Machine. At this time, the rheological data for elasticity was measured after the sample was loaded into the ARES G2 machine at 170° C. and was allowed to stand for 20 minutes with the thickness of a sample holder being lowered to 1 mm to remove bubbles, in a crossover frequency range of 0.01 to 20 Hz. Further, a storage modulus (G′) at a loss modulus (G″) of 500 Pa was calculated from the rheological data.

In addition, the zero shear viscosity (η₀) of the ethylene-acrylic acid copolymer was calculated as a viscosity when the crossover frequency converged to 0 by regression of the data using a cross model.

### 2. Measurement of Average Molecular Weight, Polydispersity Index, and Molecular Weight Distribution

The average molecular weight, the polydispersity, and the molecular weight distribution (cumulative concentration fraction of 0.75 or more) of the ethylene-acrylic acid copolymer were measured using gel permeation chromatography (GPC). At this time, it was difficult to find a combination of an appropriate solvent and a column for the ethylene-acrylic acid copolymer due to a difference in polarity between ethylene and acrylic acid, and it was also difficult to solve an interaction problem of a hydrogen bond of a pure copolymer and an acid group of a GPC column. In order to avoid the interaction, the acid group of the copolymer was esterified, methylated, and silylated, and the ethylene-acrylic acid copolymer was silylated for GPC analysis. At this time, the temperature during the measurement was 160° C., trichlorobenzene was used as a solvent, and polystyrene was used as a standard sample, thereby calculating a molecular weight.

### Evaluation of Long-Term Adhesive Strength of Ethylene-Acrylic Acid Copolymer

A laminated sheet (Al/EAA/LDPE multi-layer) obtained by co-extrusion lamination after the adhesive formed an adhesive layer between an aluminum metal sheet and a low density polyethylene sheet was added to a container containing a citric acid aqueous solution (3 wt %) at 45° C. and the container was sealed. Subsequently, the container was allowed to stand under constant temperature conditions at 45° C., the time taken to lose adhesive strength using a peel tester (TA Instrument) was measured, and the results are shown in the following Table 1.

### Examples 2 to 5

Ethylene-acrylic acid copolymers were prepared in the same manner as in Example 1, except that the ethylene-acrylic acid copolymers were prepared by adjusting the pressure, the temperature, and the initiator content so that the zero shear viscosity (η₀) and the storage modulus (G′) of the ethylene-acrylic acid copolymers prepared as shown in the following Table 1 were made different. Further, the zero shear viscosity (η₀), the elasticity, and the long-term adhesive strength of the prepared ethylene-acrylic acid copolymer were measured in the same manner as in Example 1, and the results are shown in the following Table 1.

Specifically, the process was performed in the same manner as in Example 1, except that in Example 2, the pressure, the temperature, and the initiator flow rate were adjusted to 2180 bar, the reactor upper temperature of 232° C., the reactor lower temperature of 244° C., and the initiator mixed solution flow rate of 53 L/hr, respectively; in Example 3, the pressure, the temperature, and the initiator flow rate were adjusted to 2200 bar, the reactor upper temperature of 235° C., the reactor lower temperature of 248° C., and the initiator mixed solution flow rate of 42 L/hr, respectively; in Example 4, the pressure, the temperature, and the initiator flow rate were adjusted to 2225 bar, the reactor upper temperature of 235° C., the reactor lower temperature of 248° C., and the initiator mixed solution flow rate of 45 L/hr, respectively; and in Example 5, the pressure, the temperature, and the initiator flow rate were adjusted to 2160 bar, the reactor upper temperature of 235° C., the reactor lower temperature of 249° C., and the initiator mixed solution flow rate of 33 L/hr, respectively.

### Comparative Examples 1 to 4

Ethylene-acrylic acid copolymers were prepared in the same manner as in Example 1, except that the ethylene-acrylic acid copolymers having the numerical ranges of the zero shear viscosity (η₀) and the storage modulus (G′) outside those suggested in the present disclosure were prepared by controlling the pressure, the temperature, and the initiator content.

Comparative Examples 1 to 4 were conducted in the same manner as Example 1, except for the temperature, pressure, and the initiator mixed flow rate, and specifically:

Comparative Example 1 was set with a pressure of 2,245 bar, an upper reactor temperature of 235° C., a lower reactor temperature of 249° C., and the initiator mixed solution flow rate of 35 L/hr, which follows the same reaction process as in Example 1.

Comparative Example 2 was set with a pressure of 2,247 bar, an upper reactor temperature of 235° C., a lower reactor temperature of 251° C., and the initiator mixed flow rate of 32 L/hr, which follows the same reaction process as in Example 1.

Comparative Example 3 was set with a pressure of 2,200 bar, an upper reactor temperature of 235° C., a lower reactor temperature of 250° C., and the initiator mixed flow rate of 29 L/hr, which follows the same reaction process as in Example 1.

Comparative Example 4 was set with a pressure of 2,190 bar, an upper reactor temperature of 233° C., a lower reactor temperature of 244° C., and the initiator mixed flow rate of 55 L/hr, which follows the same reaction process as in Example 1.

The zero shear viscosity (η₀), the elasticity, and the long-term adhesive strength of the prepared ethylene-acrylic acid copolymer were measured in the same manner as in Example 1, and the results are shown in the following Table 1.

The following Table 1 shows the results for the zero shear viscosity, the storage modulus at the loss modulus of 500 Pa, the average molecular weight (Mw, Mn, Mz), the polydispersity index (PDI), weight average molecular weight of the polymer having a cumulative concentration fraction of 0.75 or more, and the long-term adhesive strength (adhesive strength retention period) of the ethylene-acrylic acid copolymers of Examples 1 to 5 and Comparative Examples 1 to 4:

TABLE 1

| | Example | | | | | Comparative Example | | | |
|---|---|---|---|---|---|---|---|---|---|
| | 1 | 2 | 3 | 4 | 5 | 1 | 2 | 3 | 4 |
| η₀ | 4,735 | 5,026 | 4246 | 3,926 | 4,607 | 3,273 | 3,063 | 3,681 | 4,644 |
| G′ | 96.0 | 93.3 | 92.3 | 92.7 | 91.2 | 84.8 | 84.8 | 93.8 | 87.6 |
| Mn | 17,454 | 17,139 | 17,214 | 17,132 | 19,253 | 16,025 | 16,656 | 16,881 | 16,381 |
| Mw | 114,746 | 110,329 | 110,311 | 108,087 | 119,002 | 92,562 | 93,915 | 100,704 | 92,814 |
| Mz | 480,734 | 448,386 | 441,059 | 424,019 | 466,988 | 333,853 | 348,778 | 387,491 | 357,217 |
| PDI | 6.574 | 6.437 | 6.408 | 6.309 | 6.181 | 5.776 | 5.639 | 5.966 | 5.666 |
| Mw | 262,169 | 252,356 | 243,305 | 245,401 | 290,510 | 215,298 | 213,892 | 216,218 | 218,541 |
| (cumulative | | | | | | | | | |
| concentration | | | | | | | | | |
| fraction | | | | | | | | | |
| ≥0.75) | | | | | | | | | |
| Adhesive | 15 or | 15 or | 15 or | 15 or | 15 or | 12 or | 12 or | 12 or | 12 or |
| strength | more | more | more | more | more | less | less | less | less |
| retention | | | | | | | | | |
| period | | | | | | | | | |
| (days) | | | | | | | | | |

Referring to Table 1, the examples where the zero shear viscosity (η₀) at 170° C. is 3,800 Pa·s or more, and the storage modulus (G′) measured at a loss modulus (G″) of 500 Pa is 90 Pa or more, in the crossover frequency range of 0.01 to 20 Hz at 170° C., showed an adhesive strength retention period of 15 days or more. However, the comparative examples having the zero shear viscosity (η₀) of less than 3,800 Pas and the storage modulus (G′) of less than 90 Pa had the adhesive strength retention period of 12 days or less. Therefore, it was confirmed from Table 1 that the long-term adhesive strength of the examples satisfying the zero shear viscosity (η₀) and the storage modulus (G′) in the specific ranges was better by 30% or less than that of the comparative examples which did not satisfy the range. In addition, upon comparison with Comparative Examples 3 and 4 based on the examples, an excellent long-term adhesive strength effect was implemented only when both the zero shear viscosity (η₀) in the specific range and the storage modulus (G′) in the specific range were satisfied, and when any one of the two was not satisfied, the effect was not implemented. Besides, it was confirmed from Table 1 that Example 1 having an excellent long-term adhesive strength effect had the weight average molecular weight of a polymer having a cumulative concentration fraction of 0.75 or more of 262, 169 g/mol, and the molecular weight in the polymer range was significantly higher as compared with the weight average molecular weight of 213, 892 g/mol of Comparative Example 2.

In addition, it was confirmed in Examples 1 and 2 that the physical properties such as the zero shear viscosity and the storage modulus at the loss modulus of 500 Pa were maintained even after 350 days, by measurement with an advanced rheometric expansion system (ARES).

The ethylene-acrylic acid copolymer according to the present disclosure may maintain high initial adhesive properties for a long time.

What is claimed is:

1. An ethylene-acrylic acid copolymer which has
a zero shear viscosity (η₀) at 170° C. of 3,800 Pa·s or more and
a storage modulus (G′) of 90 Pa or more at a loss modulus (G″) of 500 Pa as measured at a crossover frequency of 0.01 to 20 Hz at 170° C.

2. The ethylene-acrylic acid copolymer of claim 1, wherein in the ethylene-acrylic acid copolymer in which a log M value of maximum dw/dlog M satisfies the following Equation 1, the ethylene-acrylic acid copolymer having a cumulative concentration fraction of 0.75 or more has a weight average molecular weight of 220,000 g/mol or more]:
$$4.2 \leq log M \leq 4.8 \qquad [ Equation 1 ]$$
wherein log M is a logarithmic value of a molecular weight M as a horizontal axis of the ethylene-acrylic acid copolymer measured by gel permeation chromatography, and in the range of log M, a maximum peak value of dw/dlog M obtained by differentiating a concentration fraction w by the logarithmic value of the molecular weight, log M is included.

3. The ethylene-acrylic acid copolymer of claim 1, wherein the ethylene-acrylic acid copolymer has
a weight average molecular weight/number average molecular weight (Mw/Mn) of 6 or more, and
a z average molecular weight/weight average molecular weight (Mz/Mw) of 3.9 or more.

4. The ethylene-acrylic acid copolymer of claim 3, wherein the ethylene-acrylic acid copolymer has the weight average molecular weight (Mw) of 90,000 g/mol or more, the number average molecular weight of 17,000 g/mol, and the z average molecular weight (Mz) of 400,000 g/mol or more.

5. The ethylene-acrylic acid copolymer of claim 1, wherein a content of an acrylic acid structural unit in the ethylene-acrylic acid copolymer is 1 to 30 wt % of the total weight of the copolymer.

6. The ethylene-acrylic acid copolymer of claim 1, wherein the ethylene-acrylic acid copolymer has a melt index (190° C./2.16 kg, ASTM D 1238) of 5 to 15.

7. The ethylene-acrylic acid copolymer of claim 1, wherein the ethylene-acrylic acid copolymer is prepared by polymerizing monomers at a temperature of 150 to 350° C. under a pressure of 1,000 to 5,000 bar.

8. An adhesive comprising the ethylene-acrylic acid copolymer of claim 1.

9. The adhesive of claim 8, wherein it takes 14 days or more for a laminated sheet obtained by co-extrusion lamination after the adhesive forms an adhesive layer between an aluminum metal sheet and a low-density polyethylene sheet to lose its adhesive strength in a citric acid aqueous solution (3 wt %) at 45° C.

10. A laminated sheet wherein the adhesive of claim 8 forms an adhesive layer between a metal sheet and a polymer sheet.

11. The laminated sheet of claim 10, wherein the metal sheet comprises an aluminum metal surface and the polymer sheet comprises a polyethylene film surface.

12. A pack which is formed of a laminate comprising the laminated sheet of claim 10 and has a fluid housing space.

13. A process for preparing an ethylene-acrylic acid copolymer of claim 1, comprising:
compressing one or more monomer(s) comprising an ethylene monomer and/or an acrylic acid comonomer in a first compressor to form a first compressed material;
compressing the first compressed material in a second compressor at a higher pressure to form a second compressed material;
supplying the second compressed material to a reactor; and
polymerizing the second compressed material in the reactor to form the ethylene-acrylic acid copolymer.

14. The process of claim 13, wherein the first compressed material is formed from ethylene monomer.

15. The process of claim 14, further comprising compressing an acrylic acid comonomer with the first compressed material in the second compressor to form the second compressed material.

16. The process of claim 15, further comprising polymerizing the second compressed material in the presence of an initiator in the reactor to form the ethylene-acrylic acid copolymer.

17. The process of claim 16, further comprising polymerizing the second compressed material in the presence of the initiator and a solvent in the reactor to form the ethylene-acrylic acid copolymer.

18. The process of claim 17, wherein the solvent is an initiator diluting paraffin-based solvent.

19. The process of claim 13, further comprising polymerizing the second compressed material with a chain transfer agent in the reactor to form the ethylene-acrylic acid copolymer.

20. The process of claim 13, further comprising:
separating an unreacted residue after polymerization from a discharge from the reactor and resupplying the discharge to a front end of the first compressor or a front end of the second compressor,
wherein the unreacted residue comprises at least one of an unreacted ethylene monomer, an unreacted acrylic acid comonomer, a solvent, an initiator, or other additive.
